(19) United States
(12) Patent Application Publication
(10) Pub. No.: US 2021/0277861 A1
(43) Pub. Date: Sep. 9, 2021

(54) FUEL INJECTION VALVE

(71) Applicant: DENSO CORPORATION, Kariya-city (JP)

(72) Inventors: Kouichi MOCHIZUKI, Kariya-city (JP); Koichi OHATA, Kariya-city (JP); Atsuya OKAMOTO, Kariya-city (JP); Noritsugu KATO, Kariya-city (JP); Yuki KATO, Kariya-city (JP)

(21) Appl. No.: 17/329,864

(22) Filed: May 25, 2021

Related U.S. Application Data
(63) Continuation of application No. PCT/JP2019/045592, filed on Nov. 21, 2019.

(30) Foreign Application Priority Data
Nov. 30, 2018 (JP) 2018-224613

(51) Int. Cl. F02M 61/18

(52) U.S. Cl. CPC F02M 61/18; F02M 2200/8084

(57) ABSTRACT

A fuel injection valve including: an injection hole body formed of metal and having an injection hole configured to inject fuel; and a metal holder that has a cylindrical shape having an insertion port in which the injection hole body is inserted, and is fusion welded to a portion of the injection hole body located inside the insertion port. The injection hole body includes a body-side fused portion formed by fusion welding, a heat-affected portion which is located on a side of the insertion port with respect to the body-side fused portion, and of which a tissue structure is changed due to heat of the fusion welding, and a seal portion located on an opposite side of the heat-affected portion from the body-side fused portion and extending in an annular shape around a cylinder center line of the holder to come into close contact with the holder.

### CROSS REFERENCE TO RELATED APPLICATION

The present application is a continuation application of International Patent Application No. PCT/JP2019/045592 filed on Nov. 21, 2019, which designated the U.S. and claims the benefit of priority from Japanese Patent Application No. 2018-224613 filed on Nov. 30, 2018. The entire disclosures of all of the above applications are incorporated herein by reference.

### TECHNICAL FIELD

The present disclosure relates to a fuel injection valve that injects fuel.

### BACKGROUND

Conventionally, a fuel injection valve is provided to an internal combustion engine to inject fuel.

### SUMMARY

According to an aspect of the present disclosure, a fuel injection valve comprises: an injection hole body formed of metal and having an injection hole configured to inject fuel; and a holder formed of metal in a cylindrical shape and having an insertion port in which the injection hole body is inserted. The holder is fusion welded to a portion of the injection hole body.

### BRIEF DESCRIPTION OF THE DRAWINGS

The above objectives and other objectives, features and advantages of the present disclosure will be clarified by the following detailed description with reference to the accompanying drawings. In the drawings;

FIG. 1 is a sectional view of a fuel injection valve according to a first embodiment;

FIG. 2 is an enlarged view of an injection hole portion illustrated in FIG. 1;

FIG. 3 is an enlarged view of a movable core portion illustrated in FIG. 1;

FIG. 4 is a schematic view illustrating an operation of the fuel injection valve according to the first embodiment, in the drawing, (a) illustrates a valve closed state, (b) illustrates a state where a movable core that is moved by a magnetic attraction force collides with a valve body, and (c) illustrates a state where the movable core that is further moved by the magnetic attraction force collides with a guide member;

FIG. 5 is a diagram illustrating a chromium concentration distribution of an injection hole body;

FIG. 6 is a diagram illustrating a relationship between a separation distance from a body-side fused portion and a temperature transition at a time of welding;

FIG. 7 is a view illustrating the separation distance illustrated in FIG. 6 with a positional relationship between the body-side fused portion and a heat-affected portion;

FIG. 8 is a flowchart illustrating a manufacturing procedure of the fuel injection valve according to the first embodiment;

FIG. 9 is a view illustrating a rolling roll and a measuring device used for adjusting a lift amount illustrated in FIG. 8;

FIG. 10 is a sectional view of a fuel injection valve according to a second embodiment;

FIG. 11 is a sectional view of a fuel injection valve according to a comparative example of the second embodiment;

FIG. 12 is a sectional view of a fuel injection valve according to a third embodiment;

FIG. 13 is a sectional view of a fuel injection valve according to a fourth embodiment;

FIG. 14 is a sectional view of a fuel injection valve according to a fifth embodiment;

FIG. 15 is a sectional view of a fuel injection valve according to a sixth embodiment; and

FIG. 16 is a sectional view of a fuel injection valve according to a seventh embodiment.

### DETAILED DESCRIPTION

As follow, examples of the present disclosure will be described.

According to an example of the present disclosure, a fuel injection valve includes an injection hole body formed of metal and having an injection hole configured to inject fuel, and a metal holder that is welded (fusion welded) to the injection hole body to hold the injection hole body. The holder has a cylindrical shape having an insertion port in which the injection hole body is inserted, and is welded to a portion of the injection hole body to be inserted from the insertion port.

A base material of the injection hole body contains, for example, chromium in order to have corrosion resistance. When the base material contains a large amount of carbon, chromium carbide is deposited at a location near a fused portion of the injection hole body. Due to this deposition, a heat-affected portion lacking chromium is generated at a location near the fused portion of the injection hole body. In recent internal combustion engines, an amount (EGR amount) of some of exhaust gas recirculated to intake air tends to increase, so that condensed water adhering to the injection hole body tends to become strong acid. Then, the heat-affected portion is corroded by the strongly acidic condensed water, and there is a concern that a strength of the injection hole body may be reduced.

According to an example of the present disclosure, a fuel injection valve comprises: an injection hole body formed of metal and having an injection hole configured to inject fuel; and a holder formed of metal in a cylindrical shape and having an insertion port in which the injection hole body is inserted, the holder being fusion welded to a portion of the injection hole body located inside the insertion port. The injection hole body includes a body-side fused portion formed by fusion welding, a heat-affected portion located on a side of the insertion port with respect to the body-side fused portion, a tissue structure of the heat-affected portion being changed due to heat of the fusion welding, and a seal portion located on an opposite side of the heat-affected portion from the body-side fused portion. The seal portion extends in an annular shape around a cylinder center line of the holder and is in close contact with the holder.

According to this, an injection hole body has a seal portion extending in an annular shape at a position located on the opposite side of a heat-affected portion from a body-side fused portion. Therefore, it is possible to suppress that condensed water intruded between the injection hole body and a holder reaches the heat-affected portion. Therefore, it is possible to suppress that the heat-affected portion of the injection hole body corrodes.

According to an example of the present disclosure, a fuel injection valve comprises: an injection hole body formed of metal and having an injection hole configured to inject fuel; a holder formed of metal in a cylindrical shape and having an insertion port in which the injection hole body is inserted, the holder being fusion welded to a portion of the injection hole body located inside the insertion port; and a seal member placed between the injection hole body and the holder and extends in an annular shape around a cylinder center line of the holder, the seal member being in close contact with and sealing the injection hole body and the holder. The injection hole body has a body-side fused portion formed by fusion welding, and a heat-affected portion located on a side of the insertion port with respect to the body-side fused portion, a tissue structure of the heat-affected portion being changed due to heat of the fusion welding. The seal member is placed on an opposite side of the heat-affected portion from the body-side fused portion.

According to this, the seal member extending in an annular shape is placed at a position between the injection hole body and the holder, at a position located on the opposite side of the heat-affected portion from the body-side fused portion. Therefore, it is possible to suppress that condensed water intruded between the injection hole body and a holder reaches the heat-affected portion. Therefore, it is possible to suppress that the heat-affected portion of the injection hole body corrodes.

Hereinafter, multiple embodiments of the present disclosure will be described with reference to the drawings. Duplicate description may be omitted by assigning the same reference numerals to the corresponding configuration elements in each embodiment. In a case where only a part of the configuration is described in each embodiment, the configurations of the other embodiments described above can be applied to the other parts of the configuration. Not only a combination of configurations specified in the description of each embodiment, but also, if there is no particular problem in the combination, configurations of multiple embodiments can be partially combined even if the combination is not specified. An unspecified combination of the configurations described in the multiple embodiments and modified examples is also disclosed by the following description.

### First Embodiment

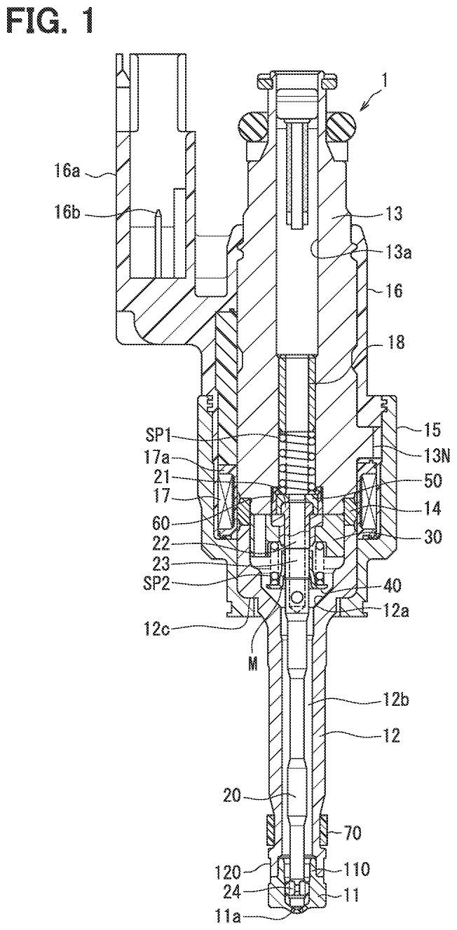

A fuel injection valve 1 illustrated in FIG. 1 is attached to a cylinder head or a cylinder block of an ignition type internal combustion engine mounted on a vehicle. Gasoline fuel stored in an in-vehicle fuel tank is pressurized by a fuel pump (not illustrated) and supplied to the fuel injection valve 1, and the supplied high-pressure fuel is injected directly into a combustion chamber of the internal combustion engine from an injection hole 11a formed in the fuel injection valve 1.

A seal material 70 is attached to an outer peripheral surface of the fuel injection valve 1. The seal material 70 seals a gap between the fuel injection valve 1 and a cylinder head. This prevents gas and condensed water in the combustion chamber from leaking to an outside of the combustion chamber through the gap.

The fuel injection valve 1 includes an injection hole body 11, a holder 12, a fixing core 13, a non-magnetic member 14, a coil 17, a support member 18, a first spring member SP1, a second spring member SP2, a needle 20, a movable core 30, a sleeve 40, a cup 50, a guide member 60, and the like. The injection hole body 11, the holder 12, the fixing core 13, the support member 18, the needle 20, the movable core 30, the sleeve 40, the cup 50, and the guide member 60 are made of metal.

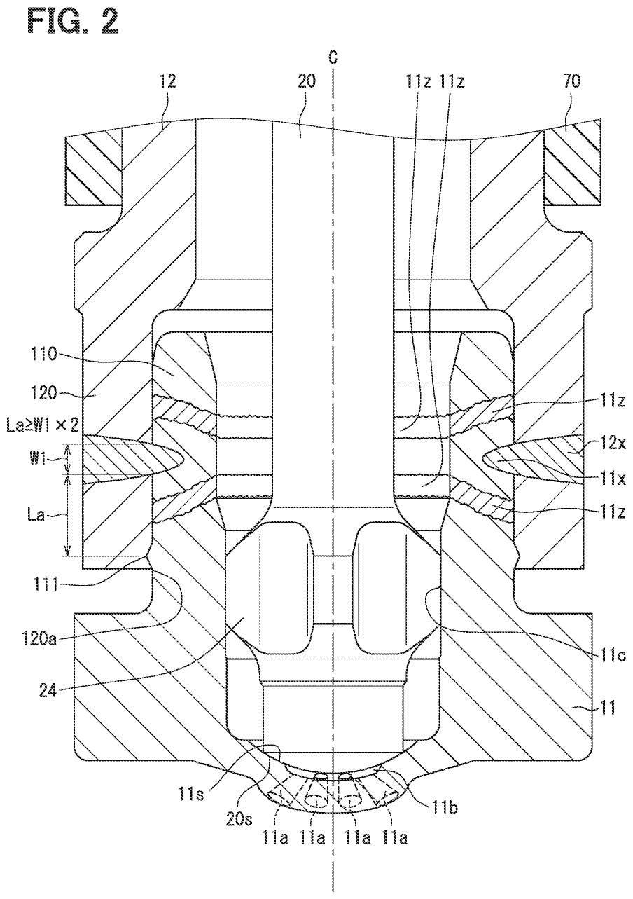

As illustrated in FIG. 2, the injection hole body 11 has multiple injection holes 11a configured to inject fuel. The needle 20 is located inside the injection hole body 11, and a flow path 11b for circulating the high-pressure fuel to the injection hole 11a is formed between an outer peripheral surface of the needle 20 and an inner peripheral surface of the injection hole body 11. On the inner peripheral surface of the injection hole body 11, a body-side seat 11s on which a valve body-side seat 20s formed on the needle 20 is detached and seated is formed. The valve body-side seat 20s and the body-side seat 11s have a shape extending in an annular shape around an axis C of the needle 20. When the needle 20 is detached and seated on the body-side seat 11s, the flow path 11b is opened and closed, and the injection hole 11a is opened and closed.

The holder 12 and the non-magnetic member 14 have a cylindrical shape. In the holder 12, a holder end portion 120, which is a cylindrical end portion of the holder 12 on a side (side of the injection hole) in a direction closer to the injection hole 11a, is fusion welded (welded) and fixed to a body end portion 110, which is a cylindrical end portion of the injection hole body 11. In the holder 12, a cylindrical end portion of the holder 12 on a side (opposite side of the injection hole) in a direction away from the injection hole 11a is welded and fixed to a cylindrical end portion of the non-magnetic member 14. A cylindrical end portion of the non-magnetic member 14 on the opposite side of the injection hole is welded and fixed to the fixing core 13.

Martensitic stainless steel is used as a material of the injection hole body 11, and ferritic stainless steel is used as a material of the holder 12. The injection hole body 11 is made of a material having a hardness higher than that of the holder 12. A carbon concentration contained in the base material of the injection hole body 11 is higher than the carbon concentration contained in the base material of the holder 12. The carbon concentration contained in the base material of the holder 12 is less than 0.02%, and the carbon concentration contained in the base material of the injection hole body 11 is 0.4% or more.

A nut member 15 is fastened to a screw portion 13N of the fixing core 13 in a state of being locked to a locking portion 12c of the holder 12. An axial force generated by this fastening causes a surface pressure that presses the nut member 15, the holder 12, the non-magnetic member 14, and the fixing core 13 against each other in the axis C direction (vertical direction in FIG. 1). Instead of generating such a surface pressure by screw fastening, it may be generated by press fitting.

The holder 12 is formed of a magnetic material and has a flow path 12b inside thereof, which allows fuel to circulate to the injection hole 11a. The needle 20 is accommodated in the flow path 12b in a movable state in the axis C direction. The holder 12 and the non-magnetic member 14 form a movable chamber 12a filled with fuel inside thereof. In the movable chamber 12a, a movable unit M, which is an assembly body to which the needle 20, the movable core 30, the second spring member SP2, the sleeve 40, and the cup 50 are assembled, is accommodated in a movable state.

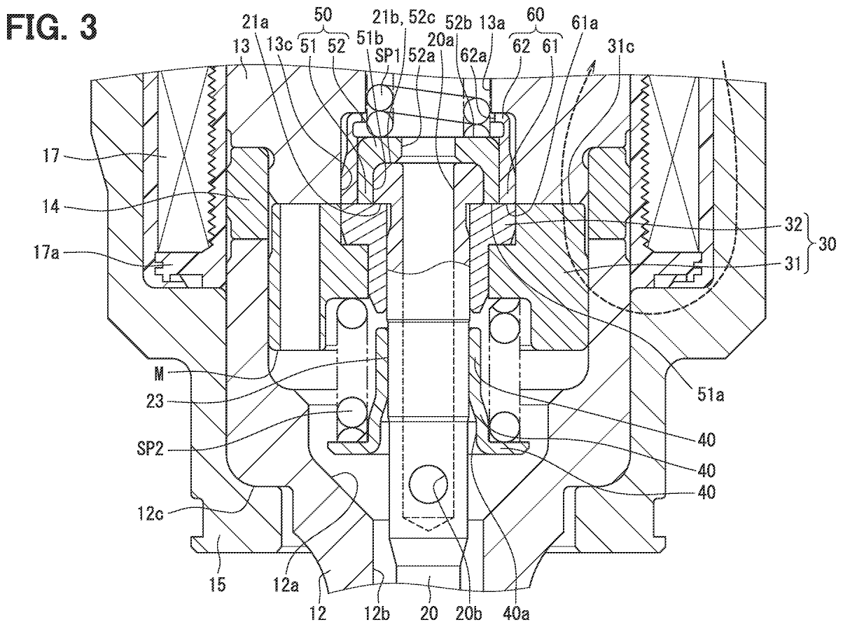

The flow path 12b communicates with the downstream side of the movable chamber 12a and has a shape extending in the axis C direction. Center lines of the flow path 12b and the movable chamber 12a coincide with the cylinder center line (axis C) of the holder 12. An injection hole-side portion of the needle 20 is slidably supported by an inner wall surface 11c (see FIG. 2) of the injection hole body 11, and an opposite-injection hole-side portion of the needle 20 is slidably supported by an inner wall surface 51b (see FIG. 3) of the cup 50. As described above, by slidably supporting two positions of an upstream end portion and a downstream end portion of the needle 20, a movement of the needle 20 in a radial direction is regulated, and a tilt of the needle 20 with respect to the axis C of the holder 12 is regulated.

The needle 20 corresponds to a “valve body” that opens and closes the injection hole 11a, is formed of a magnetic material such as stainless steel, and has a shape extending in the axis C direction. The valve body-side seat 20s described above is formed on a downstream end surface of the needle 20. When the needle 20 moves to a downstream side (valve closing operation) in the axis C direction, the valve body-side seat 20s is seated on the body-side seat 11s, and the flow path 11b and the injection hole 11a are closed. When the needle 20 moves to an upstream side in the axis C direction (valve opening operation), the valve body-side seat 20s is separated from the body-side seat 11s, and the flow path 11b and the injection hole 11a are opened.

As illustrated in FIG. 3, the needle 20 has an internal passage 20a and a horizontal hole 20b for circulating fuel to the injection hole 11a. The internal passage 20a has a shape extending in the axis C direction of the needle 20. An inflow port is formed at an upstream end of the internal passage 20a, and the horizontal hole 20b is connected to a downstream end of the internal passage 20a. The horizontal hole 20b extends in a direction intersecting the axis C direction and communicates with the movable chamber 12a.

As illustrated in FIG. 1, the needle 20 has a contact portion 21, a core sliding portion 22, a press-fitting portion 23, and an injection hole-side support portion 24 in this order from an opposite side (upper end side) of the valve body-side seat 20s to the lower end side. The contact portion 21 has a valve body contact surface 21b when the valve is closed, which contacts with a valve closing force transmission contact surface 52c of the cup 50. The cup 50 is assembled to the contact portion 21 in a slidable state, and an outer peripheral surface of the contact portion 21 slides on an inner peripheral surface of the cup 50. The movable core 30 is assembled to the core sliding portion 22 in a slidable state, and the outer peripheral surface of the core sliding portion 22 slides on the inner peripheral surface of the movable core 30. The sleeve 40 is press-fitted and fixed to the press-fitting portion 23. The injection hole-side support portion 24 is slidably supported by the inner wall surface 11c of the injection hole body 11. The cup 50 has a disk-shaped disk portion 52 and a cylindrical-shaped cylindrical portion 51. The disk portion 52 has a through-hole 52a penetrating in the axis C direction. A surface of the disk portion 52 on the opposite side of the injection hole functions as a spring contact surface 52b that contacts with the first spring member SP1. A surface of the disk portion 52 on the side of the injection hole functions as a valve closing force transmission contact surface 52c that contacts with the needle 20 and transmits a first elastic force (valve closing elastic force). The disk portion 52 functions as a “valve body transmission portion” that contacts with the first spring member SP1 and the needle 20 and transmits the first elastic force to the needle 20. The cylindrical portion 51 has a cylindrical shape extending from an outer peripheral end of the disk portion 52 toward the injection hole. An injection hole-side end surface of the cylindrical portion 51 functions as a core contact end surface 51a that contacts with the movable core 30. The inner wall surface 51b of the cylindrical portion 51 slides on the outer peripheral surface of the contact portion 21 of the needle 20.

The fixing core 13 is formed of a magnetic material such as stainless steel, and has a flow path 13a inside, which allows fuel to circulate to the injection hole 11a. The flow path 13a communicates with the internal passage 20a (see FIG. 3) formed inside the needle 20 and the upstream side of the movable chamber 12a, and has a shape extending in the axis C direction. The guide member 60, the first spring member SP1, and the support member 18 are accommodated in the flow path 13a.

The support member 18 has a cylindrical shape and is press-fitted and fixed to the inner wall surface of the fixing core 13. The first spring member SP1 is a coil spring placed on the downstream side of the support member 18, and is elastically deformed in the axis C direction. The upstream end surface of the first spring member SP1 is supported by the support member 18, and the downstream end surface of the first spring member SP1 is supported by the cup 50. The cup 50 is urged to the downstream side by a force (first elastic force) generated by the elastic deformation of the first spring member SP1. By adjusting a press-fitting amount of the support member 18 in the axis C direction, a size (first set load) of the elastic force for urging the cup 50 is adjusted.

The guide member 60 has a cylindrical shape, which is formed of a magnetic material such as stainless steel, and is press-fitted and fixed to an enlarged diameter portion 13c formed in the fixing core 13. The enlarged diameter portion 13c has a shape in which the flow path 13a is enlarged in the radial direction. The guide member 60 has a disk-shaped disk portion 62 and a cylindrical-shaped cylindrical portion 61. The disk portion 62 has a through-hole 62a penetrating in the axis C direction. A surface of the disk portion 62 on the opposite side of the injection hole contacts with an inner wall surface of the enlarged diameter portion 13c. The cylindrical portion 61 has a cylindrical shape extending from an outer peripheral end of the disk portion 62 toward the side of the injection hole. The injection hole-side end surface of the cylindrical portion 61 functions as a stopper contact end surface 61a that contacts with the movable core 30. The inner wall surface of the cylindrical portion 61 forms a sliding surface 61b that slides on the outer peripheral surface 51d of the cylindrical portion 51 related to the cup 50.

In short, the guide member 60 has a guide function of sliding the outer peripheral surface of the cup 50 moving in the axis C direction and a stopper function of regulating the movement of the movable core 30 toward the opposite side of the injection hole by contacting with the movable core 30 which moves in the axis C direction. That is, the guide member 60 functions as a “stopper member” that contacts with the movable core 30 and regulates the movement of the movable core 30 in the direction away from the injection hole 11a.

A resin member 16 is provided on the outer peripheral surface of the fixing core 13. The resin member 16 has a connector housing 16a, and a terminal 16b is accommodated inside the connector housing 16a. The terminal 16b is electrically connected to the coil 17. An external connector (not illustrated) is connected to the connector housing 16a, and power is supplied to the coil 17 through the terminal 16b. The coil 17 is wound around a bobbin 17a having electrical insulation to form a cylindrical shape, and is placed radially outward of the fixing core 13, the non-magnetic member 14, and the movable core 30. The fixing core 13, the nut member 15, the holder 12, and the movable core 30 form a magnetic circuit through which a magnetic flux generated by supplying electric power (energization) to the coil 17 flows (see a dotted arrow in FIG. 3).

The movable core 30 is placed on the side of the injection hole with respect to the fixing core 13, and is accommodated in the movable chamber 12a in a movable state in the axis C direction. The movable core 30 has an outer core 31 and an inner core 32. The outer core 31 has a cylindrical shape, which is formed of a magnetic material such as stainless steel, and the inner core 32 has a cylindrical shape, which is formed of a non-magnetic material such as stainless steel. The outer core 31 is press-fitted and fixed to an outer peripheral surface of the inner core 32.

The needle 20 is inserted to be placed inside the cylinder of the inner core 32. The inner core 32 is assembled to the needle 20 in a slidable state in the axis C with respect to the needle 20. A gap (inner gap) between the inner peripheral surface of the inner core 32 and the outer peripheral surface of the needle 20 is set to be smaller than a gap (outer gap) between the outer peripheral surface of the outer core 31 and the inner peripheral surface of the holder 12. These gaps are set such that the outer core 31 does not come into contact with the holder 12 while allowing the inner core 32 to come into contact with the needle 20.

The inner core 32 contacts with the guide member 60, the cup 50, and the needle 20 as stopper members. Therefore, the inner core 32 is made of a material having a higher hardness than that of the outer core 31. The outer core 31 has a movable-side core facing surface 31c facing the fixing core 13, and a gap is formed between the movable-side core facing surface 31c and the fixing core 13. Therefore, as described above, in a state where the coil 17 is energized and the magnetic flux flows, a magnetic attraction force attracted to the fixing core 13 acts on the outer core 31 due to the formation of the gap.

The sleeve 40 functions as a “fixing member” that is press-fitted and fixed to the needle 20 in the axis C direction. The sleeve 40 is made of a cylindrical metal having a through-hole 40a (see FIG. 3). The sleeve 40 is press-fitted and fixed to the press-fitting portion 23 of the needle 20. The sleeve 40 supports the injection hole-side end surface of the second spring member SP2. It is desirable that the needle 20 has a higher hardness than that of the sleeve 40. It is desirable that the sleeve 40 has a higher hardness than the movable core 30. A specific example of the material of the needle 20 includes martensitic stainless steel. A specific example of the material of the sleeve 40 includes ferritic stainless steel.

The second spring member SP2 is a coil spring that elastically deforms in the axis C direction. The injection hole-side end surface of the second spring member SP2 is supported by the sleeve 40, and the opposite-injection hole-side end surface is supported by the outer core 31. The outer core 31 is urged toward the opposite side of the injection hole by a force (second elastic force) generated by the elastic deformation of the second spring member SP2. By adjusting a press-fitting amount of the sleeve 40 into the needle 20, a size of the second elastic force (second set load) that urges the movable core 30 when the valve is closed is adjusted. The second set load related to the second spring member SP2 is smaller than the first set load related to the first spring member SP1. A size of the second elastic force when the movable core 30 is urged not only when the valve is closed but also in other situations may be used as the second set load adjusted by the press-fitting amount.

<Explanation of Operation>

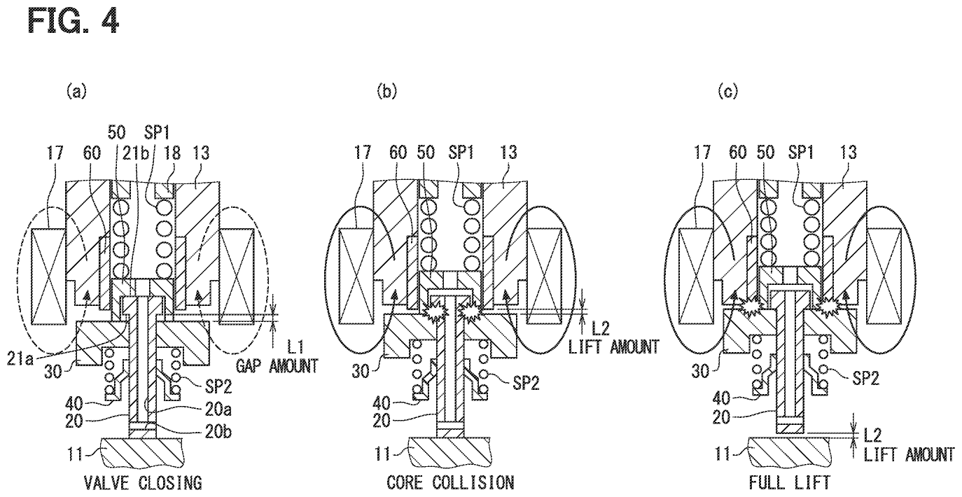

Next, an operation of the fuel injection valve 1 will be described with reference to FIG. 4.

As illustrated in a column (a) in FIG. 4, the magnetic attraction force is not generated in the state where the energization of the coil 17 is turned off, so that the magnetic attraction force urged toward the valve opening does not act on the movable core 30. The cup 50 urged to the side of the valve closing by the first elastic force of the first spring member SP1 contacts with the valve body contact surface 21b (see FIG. 3) when the valve is closed by the needle 20 and the inner core 32, and transmits the first elastic force.

The movable core 30 is urged toward the side of the valve closing by the first elastic force of the first spring member SP1 transmitted from the cup 50, and is urged toward the side of the valve opening by the second elastic force of the second spring member SP2. Since the first elastic force is larger than the second elastic force, the movable core 30 is in a state of being pushed by the cup 50 and moved (lifted down) toward the side of the injection hole. The needle 20 is urged toward the side of the valve closing by the first elastic force transmitted from the cup 50, and is in a state of being pushed by the cup 50 and moved (lifted down) toward the side of the injection hole, that is, in a state of being seated on the body-side seat 11s to close the valve. In this valve closed state, a gap is formed between the valve body contact surface 21a (see FIG. 3) when the valve opened by the needle 20 and the movable core 30 (inner core 32), and a length of the gap in the axis C direction in the valve closed state is called a gap amount L1.

As illustrated in column (b) in FIG. 4, in the state immediately after the energization of the coil 17 is switched from off to on, the magnetic attraction force urged toward the side of the valve opening acts on the movable core 30, so that the movable core 30 starts to move toward the side of the valve opening. When the movable core 30 moves while pushing up the cup 50 and an amount of the movement reaches the gap amount L1, the inner core 32 collides with the valve body contact surface 21a when the valve is opened by the needle 20. At the time of the collision, a gap is formed between the guide member 60 and the inner core 32, and a length of this gap in the axis C direction is called a lift amount L2.

During a period up to the time of the collision, the valve closing force by a fuel pressure applied to the needle 20 is not applied to the movable core 30, so that a collision speed of the movable core 30 can be increased accordingly. Since such a collision force is added to the magnetic attraction force and used as the valve opening force of the needle 20, the needle 20 can be operated to open the valve even with the high-pressure fuel while suppressing an increase in the magnetic attraction force required for valve opening.

After the collision, the movable core 30 continues to move by the magnetic attraction force, and when the amount of the movement after the collision reaches the lift amount L2, as illustrated in column (c) in FIG. 4, the inner core 32 collides with the guide member 60 to stop the movement. A separation distance between the body-side seat 11s and the valve body-side seat 20s in the axis C direction at the time of the stop of this movement corresponds to a full lift amount of the needle 20, and coincides with the lift amount L2 described above.

After that, when the energization of the coil 17 is switched from on to off, the magnetic attraction force also decreases as a drive current decreases, and the movable core 30 starts to move toward the side of the valve closing together with the cup 50. The needle 20 is pushed by the pressure of the fuel with which the portion between the needle 20 and the cup 50 is filled, and starts lift-down (valve closing operation) at the same time as the start of the movement of the movable core 30.

After that, when the needle 20 is lifted down by the lift amount L2, the valve body-side seat 20s is seated on the body-side seat 11s, and the flow path 11b and the injection hole 11a are closed. After that, the movable core 30 continues to move toward the side of the valve closing together with the cup 50, and when the cup 50 contacts with the needle 20, the movement of the cup 50 toward the side of the valve closing stops. After that, the movable core 30 further continues to move toward the side of the valve closing (inertial movement) by an inertial force, and then moves (rebounds) toward the side of the valve opening by the elastic force of the second spring member SP2. After that, the movable core 30 collides with the cup 50 and moves (rebounds) toward the side of the valve opening together with the cup 50, but is quickly pushed back by the valve closing elastic force to converge to an initial state illustrated in column (a) of FIG. 4.

Therefore, the smaller the rebound and the shorter the time required for convergence, the shorter the time to return to the initial state from the end of injection is. Therefore, when executing multi-stage injection in which fuel is injected multiple times per combustion cycle of the internal combustion engine, an interval between injections can be shortened and the number of injections included in the multi-stage injection can be increased. By shortening the convergence time as described above, it is possible to control the injection amount with high accuracy in a case where partial lift injection described below is executed. The partial lift injection is injection of a minute amount at a short valve opening time by stopping the energization to the coil 17 and starting the valve closing operation before the needle 20 that operates to open the valve reaches the full lift position.

<Structure of Injection Hole Body>

The holder end portion 120 of the holder 12 described above has a cylindrical shape having an insertion port 120a (see FIG. 2) into which the body end portion 110 of the injection hole body 11 is inserted. An inner peripheral surface of the holder end portion 120 is press-fitted into and comes into contact with the outer peripheral surface of the body end portion 110. The holder end portion 120 and the body end portion 110 are laser-welded by irradiating the outer peripheral surface of the holder end portion 120 with a laser in a state where the body end portion 110 is inserted into the holder end portion 120. The body end portion 110 is fixed to the holder end portion 120 and welded so as to exert a predetermined strength.

In the following description, in the injection hole body 11, a fused portion formed due to welding is referred to as a body-side fused portion 11x. In the holder 12, a fused portion formed due to welding is referred to as a holder-side fused portion 12x.

The fused portion (fusion) is a portion where the base material is heated by a laser, melted, and solidified. By such melting and solidification, the body-side fused portion 11x and the holder-side fused portion 12x are integrated. These fused portions are formed in an annular shape around the axis C. A range in which the body-side fused portion 11x is formed on the outer peripheral surface of the body end portion 110, that is, a length of the body-side fused portion 11x in the axis C direction is referred to as a welding width W1 of the body-side fused portion 11x. A separation distance La between the body-side fused portion 11x and the seal portion 111 on the outer peripheral surface of the body end portion 110 is larger than the welding width W1. More specifically, the separation distance La is a length that is twice or more the welding width W1.

As the material of the injection hole body 11 and the holder 12, stainless steel containing chromium, carbon or the like in iron is used. Chromium improves corrosion resistance. Carbon improves wear resistance. Since the injection hole body 11 has a body-side seat 11s with which the needle 20 collides, a material having a larger amount of carbon than that of the holder 12 is used. As the amount of carbon increases, a heat-affected portion 11z described below is likely to generate near the fused portion in accordance with an increase in temperature during welding.

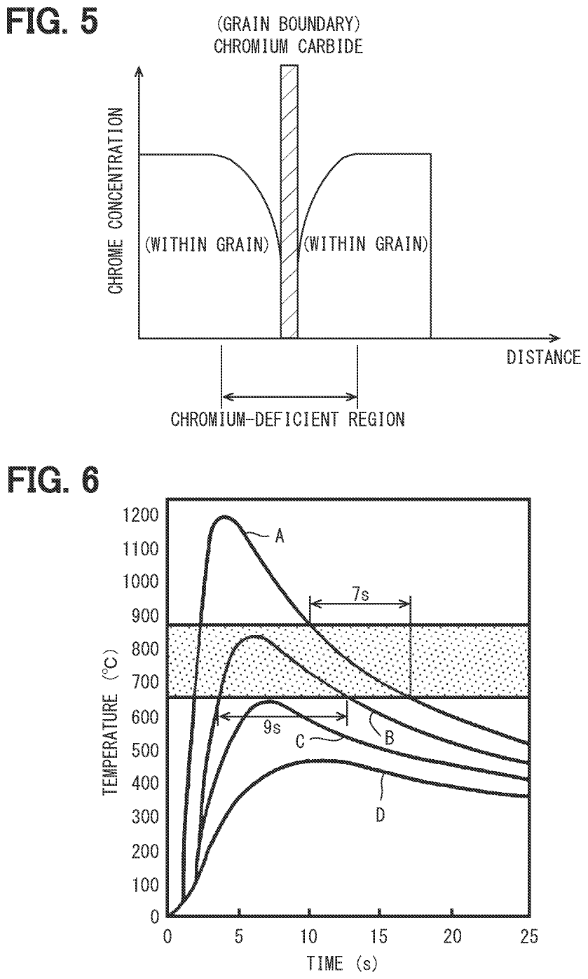

A horizontal axis of FIG. 5 indicates a distance (separation distance) in the axis C direction from the body-side fused portion 11x, and a vertical axis indicates a chromium concentration in the base material. As illustrated by diagonal lines in the drawing, in a region of the body end portion 110 where the separation distance is within a predetermined range, chromium carbide due to the bond between chromium and carbon is deposited at a grain boundary. Therefore, the region where chromium carbide is deposited at the grain boundary and a region around the region, become a chromium-deficient region in which the chromium concentration in the base material is significantly reduced. In the chromium-deficient region, the effect of corrosion resistance by chromium is reduced, and corrosion is likely to occur. The portion where chromium is deficient and it is easily corroded is the heat-affected portion 11z (heat-affected zone) described above. In short, the heat-affected portion 11z is a portion of the base material that is not melted, and an amount of chromium is reduced to an extent that the corrosion resistance is lowered due to the influence of heating at the time of welding.

In a case where the amount of carbon in the base material is small, a large amount of chromium carbide is not generated, so that a chromium-deficient region is also not generated. That is, the heat-affected portion 11z is generated at the body end portion 110 having a large amount of carbon, whereas the heat-affected portion is hardly generated at the holder end portion 120 having a smaller amount of carbon than that of the body end portion 110. The carbon content according to the present embodiment is substantially 0.4% for the injection hole body 11, substantially 0.015% for the holder 12, and a temperature at the time of welding is substantially 750° C. It is presumed that the heat-affected portion may be generated if the carbon content is 0.02% or more.

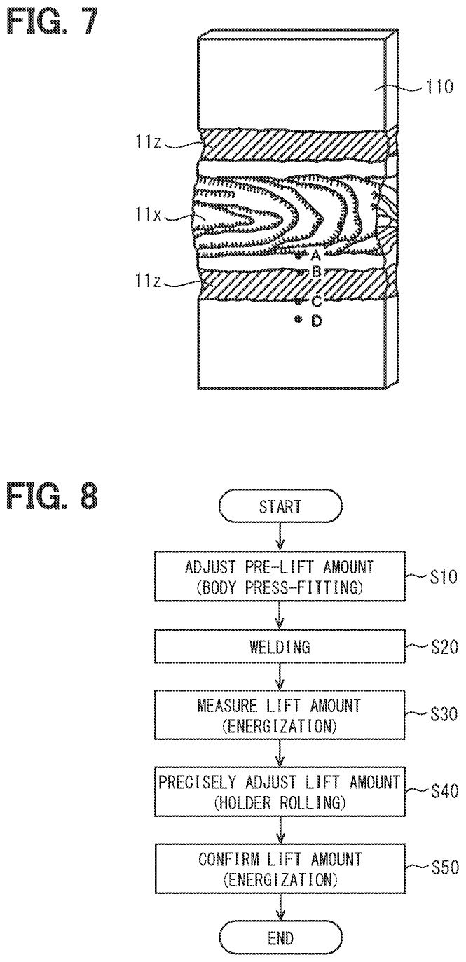

A horizontal axis of FIG. 6 indicates an elapsed time from the start of welding. A vertical axis of FIG. 6 illustrates temperature changes at four points A, B, C, and D illustrated in FIG. 7. Point A is located at a boundary between the body-side fused portion 11x and the non-fused portion. Point B is located at the heat-affected portion 11z. Point C is located at a non-heat-affected portion of a portion more separated from the body-side fused portion 11x than point B. Point D is located at the non-heat-affected portion of a portion further separated from the body-side fused portion 11x than point C.

As illustrated in FIG. 6, at each point, the temperature temporarily increases at the start of welding and decreases at the end of welding. In the process of this temperature change, a temperature region marked with dots in FIG. 6, that is, a location where the temperature of 650° C. to 850° C. is maintained for a predetermined time or longer becomes a chromium-deficient heat-affected portion. For example, since the cases of points C and D do not reach the temperature region of 650° C. to 850° C., it is a non-heat-affected portion. In the case of point B, a duration of 650° C. to 850° C. is 9 seconds, which is a predetermined time or longer, so that it is formed as the heat-affected portion 11z. In the case of point A, the duration of 650° C. to 850° C. is 7 seconds, which is a predetermined time or longer, so that the temperature is higher than that of point B, but it is the non-heat-affected portion.

As illustrated in FIG. 2, the injection hole body 11 is located on the opposite side of the heat-affected portion 11z from the body-side fused portion 11x, and has a seal portion 111 that comes into close contact with the holder 12 extending in an annular shape around the axis C (cylinder center line) of the holder 12. The seal portion 111 has a protrusion shape protruding radially outward from the outer peripheral surface of the body end portion 110, and when the body end portion 110 is press-fitted into the holder end portion 120, the seal portion 111 comes into close contact with the holder 12 while the holder end portion 120 is elasto-plastically deformed. The seal portion 111 illustrated in FIG. 2 has a triangular cross section, but may have an arc cross section.

As described above, the heat-affected portion 11z is formed at a portion of the body end portion 110 where the separation distance from the body-side fused portion 11x is within a predetermined range. In order to suppress that the condensed water in the combustion chamber reaches the heat-affected portion 11z through an intrusion path which is a gap between the body end portion 110 and the holder end portion 120, the seal portion 111 is located on the upstream side of the heat-affected portion 11z in the intrusion path. That is, the seal portion 111 is located on the opposite side of the heat-affected portion 11z from the body-side fused portion 11x in the axis C direction. As described above, the separation distance La between the body-side fused portion 11x and the seal portion 111 is set to be a length of twice or more the welding width W1. Therefore, the certainty of locating the seal portion 111 on the upstream side of the heat-affected portion 11z is improved.

The heat-affected portion 11z is generated at the body end portion 110 which is a cylindrical portion, and is distributed so as to penetrate from the outer peripheral surface to the inner peripheral surface of the body end portion 110. Therefore, the heat-affected portion 11z is exposed on both the outer peripheral surface and the inner peripheral surface of the body end portion 110. In the example of FIG. 2, the heat-affected portion 11z generated on one end side in the axis C direction and the heat-affected portion 11z generated on the other end side of the body-side fused portion 11x are connected and distributed on the inner peripheral side. On the other hand, these heat-affected portions 11z may be separated and distributed.

<Explanation of Manufacturing Method>

Next, a manufacturing method of the fuel injection valve 1 will be described.

This manufacturing method includes a movable unit assembling step, a welding step, a fastening step, a resin molding step, and a first set load adjusting step described below.

In the movable unit manufacturing step, the movable core 30, the second spring member SP2, the sleeve 40, and the cup 50 are assembled to the needle 20 to manufacture the movable unit M. The movable unit M is manufactured such that the elastic force generated by the second spring member SP2 urged against the movable core 30 becomes a target value of the second set load.

In the welding step to be executed next, first, the injection hole body 11 is welded to the holder 12 to be bonded. Next, the movable unit M is placed in the movable chamber 12a of the holder 12, and then the fixing core 13 to which the support member 18 and the first spring member SP1 are assembled, the holder 12 to which the movable unit M is placed, and the non-magnetic member 14 are welded to be bonded.

In the fastening step to be executed next, the bobbin 17a in which the coil 17 is wound is placed between the nut member 15 and the fixing core 13. After that, by fastening the nut member 15 to the fixing core 13, the holder 12, the non-magnetic member 14, and the fixing core 13 are assembled by generating a surface pressure.

In the resin molding step to be executed next, the resin member 16 having the connector housing 16a is resin-molded by pouring fused resin into the outer peripheral surface of the fixing core 13 and solidifying the fused resin.

In the first set load adjusting step performed thereafter, first, the first spring member SP1 is assembled to the flow path 13a of the fixing core 13. After that, the support member 18 is press-fitted into the flow path 13a of the fixing core 13 until a predetermined position. The predetermined position related to the press fitting may be determined according to a variation in an elastic modulus of the first spring member SP1 and the length in the axis C direction, and a variation in the dimension of each portion of the fixing core 13. In any case, the predetermined position (press-fitting position) is set such that the first elastic force urged against the needle 20 becomes the target value of the first set load. The fuel injection valve 1 is manufactured by the manufacturing method including each of the above steps.

The above-mentioned injection hole body assembling step includes a press-fitting step S10 and a welding step S20 illustrated in FIG. 8. The manufacturing method of the fuel injection valve 1 includes a measuring step S30, a rolling step S40, and a confirmation step S50 illustrated in FIG. 8.

In the press-fitting step S10, the body end portion 110 of the injection hole body 11 is press-fitted into the holder end portion 120 of the holder 12. The lift amount L2 of the needle 20 changes according to the amount of the press-fitting. Therefore, the amount of the press-fitting is set such that the lift amount L2 becomes a desired value. However, this press-fitting step S10 temporarily adjusts the lift amount L2, and the lift amount L2 is precisely adjusted by the rolling step S40 described later.

In the welding step S20 to be executed next, the outer peripheral surface of the holder end portion 120 is irradiated with a multimode laser. Therefore, the body end portion 110 and the holder end portion 120 are laser-welded to form the body-side fused portion 11x and the holder-side fused portion 12x.

In the welding step S20, for example, a processing head of a laser welding apparatus is moved around the holder 12 once, so that laser-welding is performed in an annular shape.

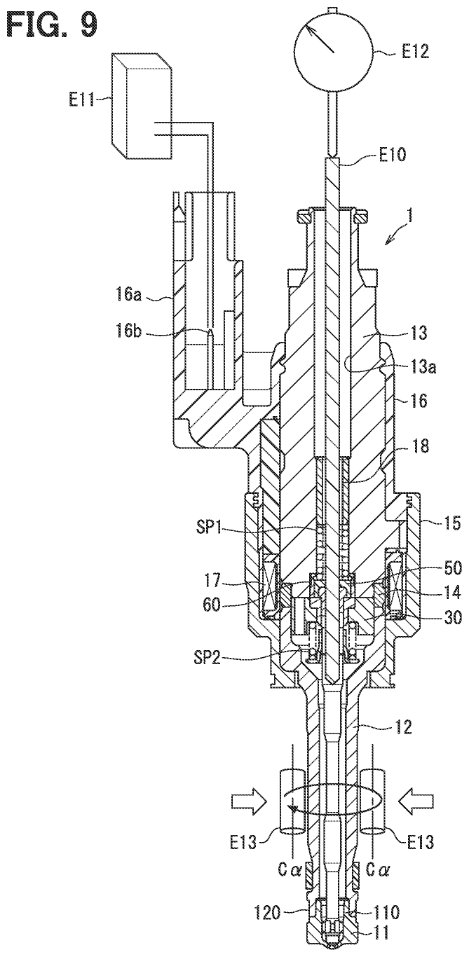

The measuring step S30 to be executed next is performed after the resin molding step or the first set load adjusting step. In the measuring step S30, the lift amount L2 is measured by the following procedure. First, as illustrated in FIG. 9, a rod-shaped measuring jig E10 is inserted into the flow path 13a of the fixing core 13 and the internal passage 20a of the needle 20, and one end of the measuring jig E10 is pressed against the needle 20. Next, the terminal 16b is energized by an energizing device El 1 to cause the needle 20 to operate to open the valve from the valve closing position to the full lift position. Before and after the energization, the lift amount L2 is measured by measuring an amount of a movement of the other end of the measuring jig E10 by a stroke meter E12.

In the rolling step S40 to be executed next, a rolling roll E13 is pressed against the outer peripheral surface of the holder 12 to apply an external force in a direction of compressing the holder 12 in the radial direction. Therefore, the holder 12 is plastically deformed such that an outer diameter dimension of the holder 12 is reduced and the dimension of the holder 12 in the axis C direction is expanded. When the dimension of the holder 12 in the axis C direction is expanded, the separation distance between the stopper contact end surface 61a and the body-side seat 11s in the axis C direction becomes longer. This means that the lift amount L2 becomes large.

Multiple rolling rolls E13 are placed in a rotatable state so that a rotation axis Ca is oriented parallel to the axis C. The multiple rolling rolls E13 are placed at equal intervals in a revolveable state in a circumferential direction of the holder 12. The location where the holder 12 receives the external force from the rolling roll E13 is a portion located on the opposite side of the holder end portion 120 from the injection hole and on the side of the injection hole from the nut member 15.

In the confirmation step S50 to be executed next, the lift amount L2 is measured by using the measuring jig E10, the energizing device E11, and the stroke meter E12 in the same manner as in the measuring step S30. In a case where the lift amount L2 measured in this way is smaller than a desired lift amount, rolling by the rolling step S40 is executed again.

In short, in the procedure illustrated in FIG. 8, first, the lift amount L2 is temporarily adjusted by press fitting, and the surface pressure is increased at the seal portion 111. After that, the injection hole body 11 is laser-welded to the holder 12, and then the lift amount L2 is precisely adjusted by rolling. According to this, even in a case where the holder 12 and the injection hole body 11 are deformed due to the influence of heat by the laser welding and the lift amount L2 changes, the lift amount L2 is precisely adjusted in the subsequent rolling, and thereby the lift amount L2 can be adjusted with high precision.

As described above, the injection hole body 11 according to the present embodiment has the body-side fused portion 11x integrated with the holder-side fused portion 12x, the heat-affected portion 11z, and the seal portion 111. The body-side fused portion 11x is formed by being melted and solidified by the laser welding (fusion welding). The heat-affected portion 11z is a portion which is located on a side of the insertion port 120a with respect to the body-side fused portion 11x, and of which a tissue structure is changed although the portion is not melted by the heat of the laser welding. The seal portion 111 is located by being separated on the opposite side of the heat-affected portion 11z from the body-side fused portion 11x, extends in an annular shape around the cylinder center line (axis C) of the holder 12, and comes into close contact with the holder 12.

Therefore, the seal portion 111 extending in the annular shape is provided between the injection hole body 11 and the holder 12 at a position located on the opposite side of the heat-affected portion 11z from the body-side fused portion 11x. Therefore, the seal portion 111 can block the condensed water in the combustion chamber from reaching the heat-affected portion 11z through the intrusion path which is the gap between the body end portion 110 and the holder end portion 120. Therefore, even in a case where the condensed water adhering to the injection hole body 11 is a strong acid due to a sulfur component contained in a part (EGR gas) of the exhaust gas recirculated to the intake air of the internal combustion engine, corrosion of the heat-affected portion 11z by the condensed water can be suppressed.

In the present embodiment, the seal portion 111 has a protrusion shape protruding radially outward from the outer peripheral surface of the injection hole body 11, and causes the holder 12 to come into close contact with the holder 12 while being elasto-plastically deformed. Therefore, the number of components can be reduced as compared with that of a case where a seal member is interposed between the injection hole body 11 and the holder 12 for sealing. Since the seal can be realized by performing the press-fitting step 510 for temporarily adjusting the lift amount L2, an operation process required for the seal can be reduced.

The fuel injection valve 1 according to the present embodiment includes a core boost structure described below. That is, a structure is provided in which when the needle 20 is operated to open the valve, first, the movable core 30 starts the movement in a state of being not engaged with the needle 20, and then when the movable core 30 moves by a predetermined amount, the movable core 30 contacts with the needle 20 and thereby the valve opening operation is started.

According to such a core boost structure, since the movable core 30 is not yet engaged with the needle 20 immediately after the start of energization, in the movable core 30 which is not subjected to the force of the fuel pressure, a moving speed of the movable core 30 can be quickly increased with a small initial magnetomotive force. When the moving speed becomes sufficiently fast, that is, when the movable core 30 moves by a predetermined amount, the movable core 30 contacts with the needle 20 to start the valve opening operation, so that the valve can be opened by utilizing the collision force of the movable core 30 in addition to the magnetic attraction force. Therefore, the needle 20 can be operated to open the valve even with high-pressure fuel while suppressing an increase in the magnetic attraction force required for valve opening.

### Second Embodiment

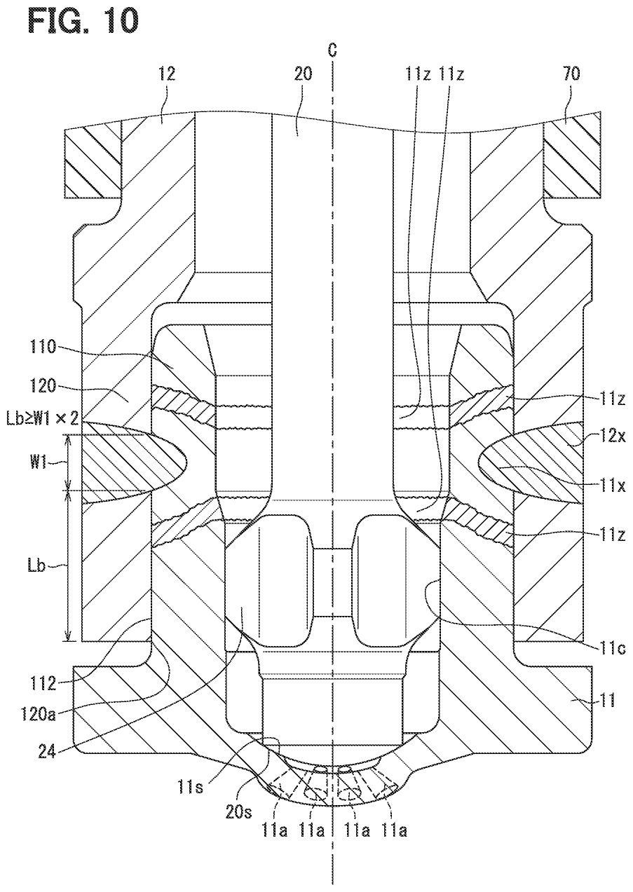

In the first embodiment, the seal portion 111 of the protrusion shape formed at the body end portion 110 exerts the seal function. On the other hand, in the present embodiment, a seal press-fitting surface 112, which is a portion of the outer peripheral surface of the body end portion 110 located on the side of the insertion port 120a with respect to the body-side fused portion 11x, is set sufficiently long to exert the seal function. Specifically, as illustrated in FIG. 10, a seal length Lb, which is a length of the seal press-fitting surface 112 in the axis C direction, is set to be twice or more the welding width W1 of the body-side fused portion 11x.

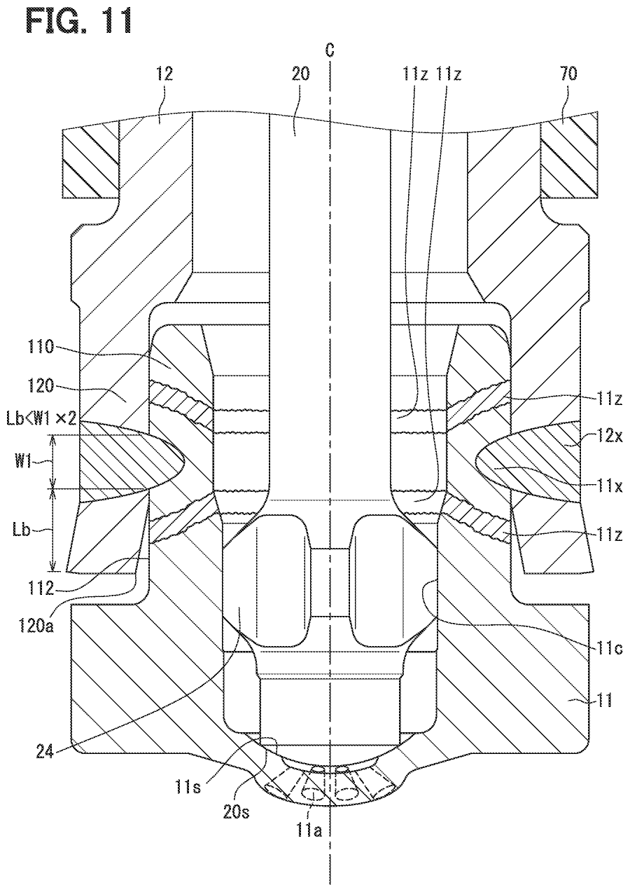

Here, contrary to the present embodiment, in a case where the seal length Lb is set to less than twice the welding width W1, as illustrated in FIG. 11, the portion of the seal press-fitting surface 112 in the body end portion 110 is easy to be deformed to expand in the radial direction. It is presumed that this deformation is generated by the influence of heat at the time of welding related to the body-side fused portion 11x and the holder-side fused portion 12x.

On the other hand, according to the present embodiment in which the seal length Lb is set to be twice or more the welding width W1, the possibility of the above deformation can be suppressed and a sufficient seal function is exerted. Therefore, it is possible to suppress that the condensed water intruded between the injection hole body 11 and the holder 12 reaches the heat-affected portion 11z.

The seal press-fitting surface 112 according to the present embodiment is placed between the injection hole body 11 and the holder 12, extends in an annular shape around the axis C, and functions as the seal portion that comes into close contact with and seals the holder 12.

### Third Embodiment

In the first embodiment, the seal portion 111 of the protrusion shape formed at the body end portion 110 exerts the seal function, whereas in the present embodiment, a caulking structure described in detail below exerts the seal function.

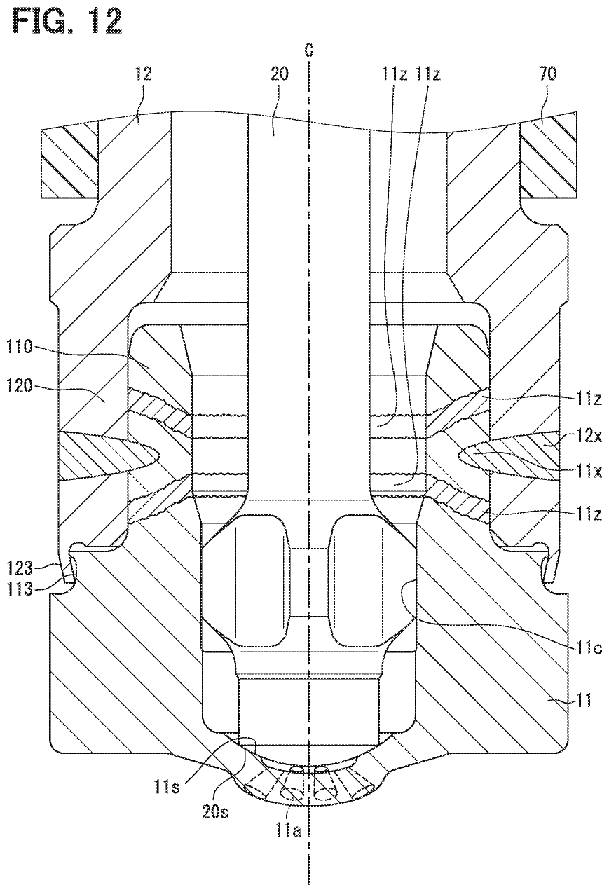

Specifically, as illustrated in FIG. 12, a crimped portion 123, which has a thinner wall thickness than a portion in which the holder-side fused portion 12x is formed, is formed at a tip of the holder end portion 120. The crimped portion 123 has a cylindrical shape extending in an annular shape around the axis C.

In a portion of the body end portion 110 located on the opposite side of the heat-affected portion 11z from the body-side fused portion 11x, a crimped portion 113, which is crimped by the crimped portion 123 and comes into close contact with the holder end portion 120, is formed. The crimped portion 113 has a shape extending in an annular shape around the axis C. The crimped portion 123 is plastically deformed in a direction in which a diameter is reduced. Therefore, an inner peripheral surface of the crimped portion 123 is pressed against an outer peripheral surface of the crimped portion 113 and comes into close contact therewith.

As described above, according to the present embodiment, the crimped portion 113 (seal portion) extending in an annular shape is provided at a location between the injection hole body 11 and the holder 12 on the opposite side of the heat-affected portion 11z from the body-side fused portion 11x. Therefore, it is possible to suppress that the condensed water intruded between the injection hole body 11 and the holder 12 reaches the heat-affected portion 11z, and suppress corrosion of the injection hole body 11.

In the present embodiment, the seal function is exerted by the caulking structure of the crimped portion 123 and the crimped portion 113.

### Fourth Embodiment

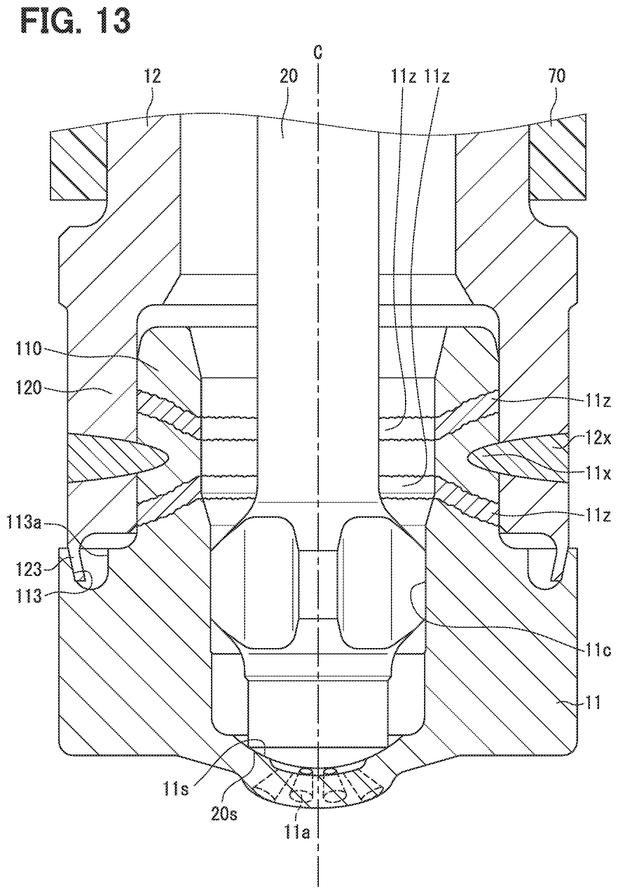

In the third embodiment, the inner peripheral surface of the crimped portion 123 is pressed against the outer peripheral surface of the crimped portion 113 and comes into close contact therewith. On the other hand, in the present embodiment, as illustrated in FIG. 13, the outer peripheral surface of the crimped portion 123 is pressed against the inner peripheral surface of the crimped portion 113 and comes into close contact tact therewith. The crimped portion 113 is formed on a wall surface of a groove 113a formed in the injection hole body 11. A diameter of the groove 113a is set smaller than a diameter of the crimped portion 123.

In the case of the third embodiment, the crimped portion 123 is plastically deformed by using an instrument that presses the outer peripheral surface of the crimped portion 123 in a diameter reduction direction. On the other hand, in the case of the present embodiment, the crimped portion 123 is plastically deformed by inserting the crimped portion 123 into the groove 113a formed in the injection hole body 11.

### Fifth Embodiment

In the first embodiment, the seal function is exhibited in a part (seal portion 111) of the injection hole body 11. On the other hand, in the present embodiment, the seal function is exerted by a seal member 80 described below, which is a member separated from the injection hole body 11 and the holder 12.

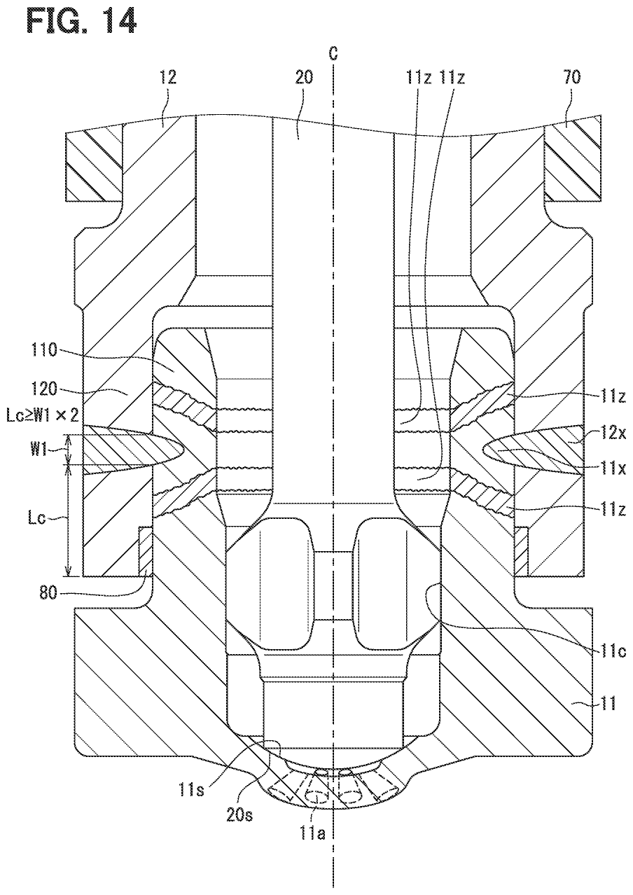

Specifically, as illustrated in FIG. 14, a seal member 80 having a cylindrical shape is placed between a portion of the outer peripheral surface of the body end portion 110 located on the opposite side of the heat-affected portion 11z from the body-side fused portion 11x and the inner peripheral surface of the holder end portion 120. An elastic body having heat resistance and corrosion resistance is used for the seal member 80. The seal member 80 is placed between the outer peripheral surface of the body end portion 110 and the inner peripheral surface of the holder end portion 120 in a state of being elastically deformed in the direction of being compressed in the radial direction.

In order to secure a sufficient length of the seal member 80 in the axis C direction, a length Lc of a portion of the outer peripheral surface of the body end portion 110 located on the side of the insertion port 120a with respect to the body-side fused portion 11x in the axis C direction is set to be twice or more the welding width W1 of the body-side fused portion 11x.

As described above, according to the present embodiment, the seal member 80 extending in an annular shape is placed between the injection hole body 11 and the holder 12 at a position located on the opposite side of the heat-affected portion 11z from the body-side fused portion 11x. Therefore, it is possible to suppress that the condensed water intruded between the injection hole body 11 and the holder 12 reaches the heat-affected portion 11z, and suppress corrosion of the injection hole body 11.

### Sixth Embodiment

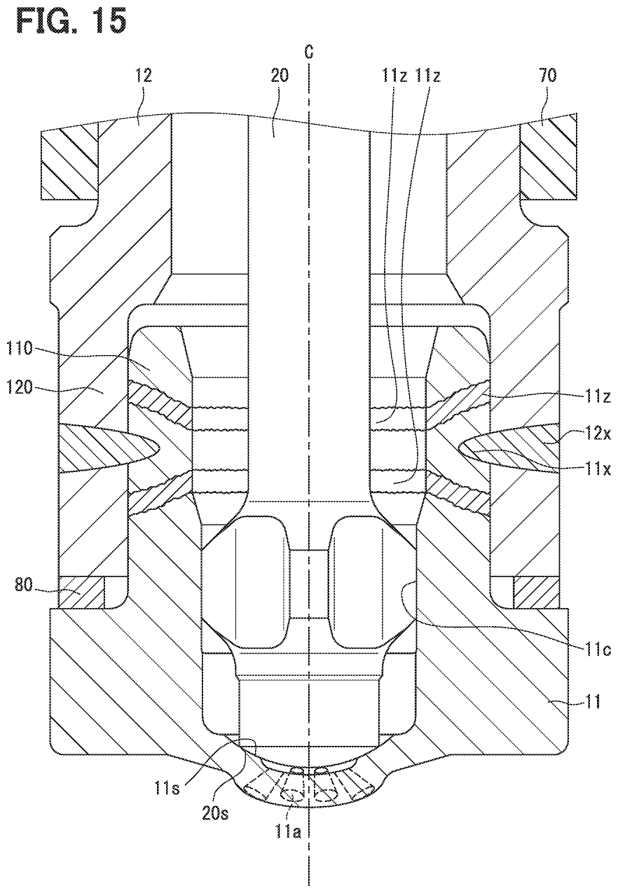

In the fifth embodiment, the seal member 80 is placed between the outer peripheral surface of the body end portion 110 and the inner peripheral surface of the holder end portion 120 in a state of being elastically deformed in the direction of being compressed in the radial direction. On the other hand, in the present embodiment, as illustrated in FIG. 15, the seal member 80 is placed between an end surface of the body end portion 110 in the axial direction and the injection hole body 11 in a state of being elastically deformed in the direction of being compressed in the axis C direction.

### Seventh Embodiment

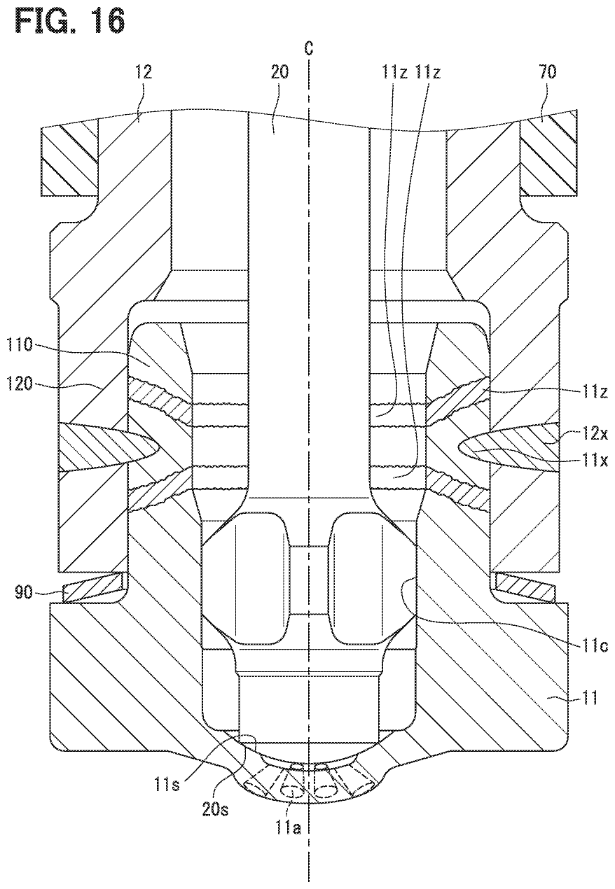

In the present embodiment, a disc spring 90 illustrated in FIG. 16 is used as the seal member instead of the seal member 80 according to the fifth embodiment. The disc spring 90 is placed between the end surface of the body end portion 110 in the axial direction and the injection hole body 11 in a state of being elastically deformed in the axis C direction.

In the example illustrated in FIG. 16, an inner peripheral end of the disc spring 90 contacts with the holder end portion 120, and an outer peripheral end of the disc spring 90 contacts with the injection hole body 11. On the other hand, the inner peripheral end of the disc spring 90 may contact with the injection hole body 11, and the outer peripheral end of the disc spring 90 may contact with the holder end portion 120.

### Other Embodiments

The disclosure in this specification is not limited to the combination of components and/or elements illustrated in the embodiments. The disclosure can have additional portions that can be added to the embodiments. The disclosure includes one in which the components and/or elements of the embodiments are omitted. The disclosure includes a replacements or a combination of components and/or elements between one embodiment and the other.

In the first embodiment, the seal portion 111 of the protrusion shape is formed on the outer peripheral surface of the body end portion 110, but may be formed on the inner peripheral surface of the holder end portion 120. In the first and second embodiments, as illustrated in the press-fitting step S10 of FIG. 8, it is essential to press-fit the injection hole body 11 into the holder 12, but in other embodiments, the press-fitting of the injection hole body 11 into the holder 12 may be abolished.

In the third and fourth embodiments, the crimped portion 123 is formed in the holder 12 and the crimped portion 113 is formed in the injection hole body 11, but the crimped portion 123 may be formed in the injection hole body 11 and the crimped portion 113 may be formed in the holder 12.

In the fifth to seventh embodiments, the seal members 80 and 90 are elastic bodies placed between the injection hole body 11 and the holder 12 in a state of being elastically deformed. On the other hand, the members placed between the injection hole body 11 and the holder 12 in the state of being plastically deformed may be replaced with the seal members 80 and 90.

In the first embodiment, the movable unit M is supported in the radial direction at two locations of the portion of the needle 20 (needle tip portion) facing the inner wall surface 11c of the injection hole body 11 and the outer peripheral surface 51d of the cup 50. On the other hand, the movable unit M may be supported from the radial direction at two locations of the outer peripheral surface of the movable core 30 and the needle tip portion.

In the first embodiment, the inner core 32 is formed of a non-magnetic material, but it may be formed of a magnetic material. In a case where the inner core 32 is formed of the magnetic material, the inner core 32 may be formed of a weak magnetic material having a weaker magnetism than that of the outer core 31. Similarly, the needle 20 and the guide member 60 may be formed of a weak magnetic material having a weaker magnetism than that of the outer core 31.

In the first embodiment, in order to realize the core boost structure in which the movable core 30 contacts with the needle 20 to start the valve opening operation when the movable core 30 moves by a predetermined amount, the cup 50 is interposed between the first spring member SP1 and the movable core 30. On the other hand, a core boost structure may be provided in which the cup 50 is abolished, a third spring member different from the first spring member SP1 is provided, and the movable core 30 is urged toward the side of the injection hole by the third spring member.

In each of the embodiments, the core boost structure is adopted, but a structure may be provided in which the needle 20 also starts moving (valve opening operation) at the same time the movable core 30 starts moving when energized. In each of the embodiments, the two-body structure is provided in which the needle 20 and the movable core 30 are assembled in a state of being relatively movable in the axis C direction, but a structure may be provided in which the needle 20 and the movable core 30 are integrated so as to be incapable of relatively moving.

The movable core 30 according to the first embodiment has a structure having two components of the outer core 31 and the inner core 32. The inner core 32 is made of a material having a higher hardness than that of the outer core 31, and has the surface that contacts with the cup 50 and the guide member 60, and the surface that slides on the needle 20. On the other hand, the movable core 30 may have a structure in which the inner core 32 is abolished.

In a case where the movable core 30 has a structure in which the inner core 32 is abolished as described above, it is desirable that the contact surfaces of the movable core 30 with the cup 50 and the guide member 60, and a sliding surface sliding on the needle 20 are plated. Chromium is one of the specific examples of plating applied to the contact surfaces. Nickel phosphorus is one of the specific examples of plating applied to the sliding surface.

The fuel injection valve 1 according to the first embodiment has a structure in which the movable core 30 contacts with the guide member 60 attached to the fixing core 13. On the other hand, a structure may be provided in which the movable core 30 contacts with the fixing core 13 in which the guide member 60 is abolished. In short, a structure may be provided in which the inner core 32 contacts with the guide member 60, or a structure may be provided in which the inner core 32 contacts with the fixing core 13 in which the guide member 60 is abolished. A structure may be provided in which the movable core 30 in which the inner core 32 is abolished contacts with the guide member 60, or a structure may be provided in which the movable core 30 in which the inner core 32 is abolished contacts with the fixing core 13 in which the guide member 60 is abolished.

The cup 50 according to the first embodiment slides in the axis C direction while coming into contact with the inner peripheral surface of the guide member 60. On the other hand, the cup 50 may have a structure that moves in the axis C direction while forming a predetermined gap with the inner peripheral surface of the guide member 60.

In the first embodiment, one end of the second spring member SP2 is supported by the movable core 30, and the other end of the second spring member SP2 is supported by the sleeve 40 attached to the needle 20. On the other hand, the sleeve 40 may be abolished, and the other end of the second spring member SP2 may be supported by the holder 12.

In each of the embodiments, the body end portion 110 is press-fitted into the holder end portion 120, but the press fitting may be abolished. The fuel injection valve 1 according to each of the embodiments is a direct injection type that directly injects fuel into the combustion chamber of the internal combustion engine, but may be a port injection type that injects fuel into an intake passage that causes the intake air to circulate to the combustion chamber of the internal combustion engine.

What is claimed is:

1. A fuel injection valve comprising:
an injection hole body formed of metal and having an injection hole configured to inject fuel; and
a holder formed of metal in a cylindrical shape and having an insertion port in which the injection hole body is inserted, the holder being fusion welded to a portion of the injection hole body located inside the insertion port, wherein
the injection hole body includes
a body-side fused portion formed by fusion welding,
a heat-affected portion located on a side of the insertion port with respect to the body-side fused portion,
a tissue structure of the heat-affected portion being changed due to heat of the fusion welding, and
a seal portion located on an opposite side of the heat-affected portion from the body-side fused portion, wherein
the seal portion extends in an annular shape around a cylinder center line of the holder and is in close contact with the holder.

2. The fuel injection valve according to claim 1, wherein
the seal portion has a protrusion shape protruding radially outward from an outer peripheral surface of the injection hole body and is in close contact with the holder while elasto-plastically deforming the holder.

3. The fuel injection valve according to claim 1, wherein
the holder has a crimped portion at which the injection hole body is crimped, and
the seal portion is crimped with the crimped portion and is in close contact with the holder.

4. A fuel injection valve comprising:
an injection hole body formed of metal and having an injection hole configured to inject fuel;
a holder formed of metal in a cylindrical shape and having an insertion port in which the injection hole body is inserted, the holder being fusion welded to a portion of the injection hole body located inside the insertion port; and
a seal member placed between the injection hole body and the holder and extends in an annular shape around a cylinder center line of the holder, the seal member being in close contact with and sealing the injection hole body and the holder, wherein
the injection hole body has
a body-side fused portion formed by fusion welding, and
a heat-affected portion located on a side of the insertion port with respect to the body-side fused portion, a tissue structure of the heat-affected portion being changed due to heat of the fusion welding, wherein
the seal member is placed on an opposite side of the heat-affected portion from the body-side fused portion.

5. The fuel injection valve according to claim 4, wherein
the seal member is an elastic body placed between the injection hole body and the holder in an elastically deformed state.
